(19) United States
(12) Patent Application Publication
(10) Pub. No.: US 2024/0274844 A1
(43) Pub. Date: Aug. 15, 2024

(54) FUEL CELL SYSTEM AND METHOD FOR OPERATING A FUEL CELL SYSTEM

(71) Applicant: Robert Bosch GmbH, Stuttgart (DE)

(72) Inventors: Jochen Wessner, Esslingen (DE); Martin Katz, Stuttgart (DE)

(21) Appl. No.: 18/563,490

(22) PCT Filed: May 18, 2022
(86) PCT No.: PCT/EP2022/063411

§ 371 Date: Nov. 22, 2023

(30) Foreign Application Priority Data
Jun. 7, 2021 (DE) 10 2021 205 699.7

(51) Int. Cl. H01M 8/04119; H01M 8/04089; H01M 8/04111

(52) U.S. Cl. CPC H01M 8/04156; H01M 8/04097; H01M 8/04111

(57) ABSTRACT

The invention relates to a fuel cell system comprising a fuel cell assembly with at least one fuel cell, a fuel inlet, a fuel outlet, a supply line which is connected to the fuel inlet for supplying gaseous fuel, a discharge line which is connected to the fuel outlet for discharging excess fuel, a recirculation line which connects the discharge line and the supply line, a recirculation compressor which is arranged in the recirculation line and which is designed to generate a fluid flow of the excess fuel from the discharge line to the supply line, said fluid having a speed component in a circumferential direction of the recirculation line, and a water separator which is arranged between the recirculation compressor and the supply line and which comprises a receiving chamber arranged on the exterior of the recirculation line with respect to the radial direction and which is connected to the recirculation line via at least one discharge opening formed in the recirculation line in order to receive liquid constituents contained in the fluid flow.

### BACKGROUND

Fuel cells are being increasingly used as energy converters, among other things also in vehicles, in order to directly convert the chemical energy contained in a fuel, e.g. hydrogen together with oxygen, into electrical energy. Fuel cells typically comprise an anode, a cathode, and an electrolytic membrane located between the anode and the cathode. Oxidation of the fuel occurs at the anode, and a reduction of oxygen occurs at the cathode. Water is produced on the cathode side.

Typically, the anode of fuel cells is continuously supplied with gaseous fuel in excess, that is, more fuel than would be stoichiometrically necessary for a given supply of oxygen to the cathode. The excess fuel is usually recirculated or re-supplied to the anode. As the product water formed on the cathode side as a result of the chemical reaction reaches the anode side under certain circumstances, water can be included in the excess fuel, which would be re-fed to the anode when the excess fuel is recirculated.

In order to avoid excessive accumulation of water on the anode, water separation is usually carried out during the recirculation of the excess fuel. For example, JP 2005 116354 A describes a fuel cell system having a water separator in a recirculation path.

### SUMMARY

A fuel cell system and a method for operating a fuel cell system are provided.

According to a first aspect of the invention, a fuel cell system comprises a fuel cell assembly with at least one fuel cell, a fuel inlet, a fuel outlet, a supply line which is connected to the fuel inlet for supplying gaseous fuel, a discharge line which is connected to the fuel outlet for discharging excess fuel, a recirculation line which connects the discharge line and the supply line, a recirculation compressor which is arranged in the recirculation line and which is designed to generate a fluid flow of the excess fuel from the discharge line to the supply line, said fluid having a speed component in a circumferential direction of the recirculation line, and a water separator which is arranged between the recirculation compressor and the supply line and which comprises a receiving chamber arranged on the exterior of the recirculation line with respect to a radial direction and which is connected to the recirculation line via at least one discharge opening formed in the recirculation line in order to receive liquid constituents contained in the fluid flow.

According to a second aspect of the invention, a method for operating a fuel cell system is provided. The method comprises feeding a gaseous fuel to a fuel inlet of a fuel cell assembly, discharging excess fuel from the fuel cell assembly, generating a swirling flow of the excess fuel, which comprises a speed component in a circumferential direction, directing the swirling flow across a flow surface extending along the circumferential direction, in which at least one discharge opening is formed, through which liquid constituents of the flow are discharged into a collection container, and recirculating the fuel cell excess to the fuel inlet.

One idea underlying the invention is to generate a swirl of excess fuel in a flow recirculated from an outlet of a fuel cell assembly to an inlet of the fuel cell assembly such that liquid constituents, in particular product water, which has been introduced into the flow at an anode side of the fuel cell assembly, accumulate in a radially outer area of the flow due to inertial forces. The liquid constituents can thereby be easily discharged through one or more openings formed in the surface guiding the flow and perpendicular to the radial direction, so that the proportion of liquid constituents in the flow is reduced downstream of the at least one opening.

According to the invention, it is provided that the swirl or the speed component directed in the circumferential direction of the flow is generated using a recirculation compressor. For example, the recirculation line can comprise a linearly extending line section defining a central axis. The radial direction extends perpendicular to the central axis. The circumferential direction U extends perpendicular to the radial direction. The compressor is arranged in the line section and is configured to generate a flow with a main flow direction or speed component directed along the central axis. At the same time, the compressor can have a guide structure, e.g. in the form of stator blades, to generate a speed component along the circumferential direction in the flow. This is advantageous because thereby the compressor can be used both to transport or recirculate the excess fuel and to generate the swirl. It is also conceivable, e.g. for carrying out the method, that the guide device is provided separately from a transport compressor in the recirculation line. Downstream of the compressor or the guide device, at least one discharge opening is configured in a wall of the recirculation line. For example, the discharge opening can also be located in the linear line section. The wall has a flow surface that extends perpendicular to the radial direction or along the circumferential direction. For example, the flow surface can enclose the central axis. Due to the speed component of the circumferential direction flow, liquid and generally heavy constituents are transported radially outwards due to inertial forces and can be removed from the recirculation line through the discharge opening.

According to some embodiments, it can be provided that the receiving chamber of the water separator encloses an outer circumference of the recirculation line. For example, the receiving chamber can be formed by a continuous channel surrounding the recirculation line. The arrangement on the outer circumference such that the recirculation line is completely surrounded by the receiving chamber on the outside, offers the advantage that discharge openings can be provided over the entire circumference of the recirculation line or a continuous discharge opening extending over the entire circumference of the recirculation line. This further improves the efficiency of water separation. Furthermore, in this manner, the separated water or liquid automatically collects at the lowest point of the chamber relative to the direction of gravity and can be readily discharged therefrom.

According to some embodiments, it can be provided that the water separator comprises a guide piece projecting into the recirculation line with respect to the radial direction, which partially circumscribes the discharge opening. For example, the guide piece can be formed as a metal sheet protruding diagonally from the inner circumferential surface towards the compressor or the guide structure, which is arranged on an end of the discharge opening facing away from the compressor or the guide plate. A part of the flow is introduced into the receiving chamber through the guide plate relative to the radial direction on the outside. As a large part of the liquid constituents accumulates in the radially outer area of the flow due to the radial speed component of the flow, the guide plate design makes the liquid separation even more efficient.

According to some embodiments, it can be provided that the guide piece extends in an extension direction angled relative to an inner circumferential surface of the recirculation line such that a free end of the guide piece faces the recirculation compressor, and wherein the receiving chamber has a wall extending along the radial direction at a distance from the extension direction of the guide piece. Thus, the flow derived from the guide piece is directed diagonally to a wall in the receiving chamber, thereby forming a vortex flow within the receiving chamber. This further improves the water separation and, at the same time, due to the turbulence, a gaseous part can be reintroduced into the recirculation line through the discharge opening.

According to some embodiments, it can be provided that the recirculation compressor comprises a stator with stator blades and a rotor with rotor blades rotatably mounted on the stator about an axis of rotation, wherein the axis of rotation extends perpendicular to the radial direction, and wherein the stator blades and the rotor blades are inclined relative to one another, in that a flow is generated by a rotation of the rotor about the axis of rotation, which comprises a speed component along the axis of rotation and a speed component along the circumferential direction. The stator blades thus form a guide device. An advantage of the recirculation compressor with stator and rotor is that the recirculation compressor assumes both the task of transporting the excess fuel and the task of twisting the flow. By mounting the rotor on the stator, a particularly compact design is realized.

According to some embodiments, it can be provided that the rotor blades are held on a carrier ring inwardly relative to the radial direction. This results in a very stable rotor design.

According to some embodiments, it can be provided that permanent magnets are attached to the carrier ring, wherein an electrical coil array is arranged on an outer circumference of the recirculation line, which is configured to generate a magnetic field rotating about the axis of rotation to rotate the rotor about the axis of rotation. The carrier ring can thus be used to arrange individual permanent magnets around the circumference of the rotor. The permanent magnets are thus arranged within the recirculation line. Furthermore, a coil array with one or more induction coils is arranged outside the recirculation line to generate a rotating magnetic field. In this way, the advantage is achieved that the electrical lines necessary for the electrical connection of the coil array need not be inserted into the recirculation line. This further improves the tightness of the recirculation line.

According to some embodiments, it can be provided that the carrier ring on an outer circumferential surface comprises recesses in which the permanent magnets are arranged, wherein a sleeve covering the recesses and the permanent magnets arranged therein is arranged on the outer circumferential surface of the carrier ring. The sleeve thus forms a cover for the permanent magnets. The permanent magnets are thereby protected from influences by the fuel flowing in the recirculation line, e.g. hydrogen.

According to some embodiments, it can be provided that the fuel cell system comprises a suction jet pump arranged in the supply line. The suction jet pump can have a propel nozzle connected to an inlet of the supply line, a suction inlet connected to the recirculation line, and an output connected to the fuel inlet of the fuel cell assembly. For example, the suction jet pump can receive fuel from a high pressure reservoir at its propel nozzle and supply it via its output to the fuel inlet of the fuel cell assembly. Fuel is drawn from the recirculation line via the suction inlet. As a result, recirculation can occur even if the recirculation compressor is not running. As described, since the recirculation compressor comprises a guide device, a speed component can also be generated in this case in the flow in the recirculation line in the circumferential direction. The suction jet pump provides the advantage, in particular in combination with the recirculation compressor, that a fuel mass flow can be adapted even more flexibly to the load state of the fuel cell assembly.

It can generally be provided that the receiving chamber and the recirculation line are connected to one another in a material locking fashion, in particular welded to one another. This improves the seal between the receiving chamber and recirculation line.

For example, in the context of the present disclosure, the fuel can be hydrogen or a gaseous organic compound, such as methane, butane, or natural gas.

The fuel cell assembly can generally comprise a plurality of individual fuel cells arranged into a so-called stack, wherein the fuel cells each comprise an anode, a cathode and an electrolytic membrane arranged between the anode and the cathode. Fuel is supplied via the fuel inlet to the anodes. Oxygen is supplied to the cathodes via an oxygen inlet.

### BRIEF DESCRIPTION OF THE FIGURES

The invention will be explained below with reference to the figures of the drawings. The drawings show:

FIG. 1 a schematic view of a flow diagram of a fuel cell system according to an embodiment example of the invention;

FIG. 2 a schematic cross-sectional view of a line section of a recirculation line of a fuel cell system according to an embodiment example of the present invention;

FIG. 3 a magnified representation of the area marked in FIG. 2 by the letter Z; and

FIG. 4 a flowchart of a method according to an embodiment example of the invention.

Unless otherwise stated, identical reference numbers refer to identical or functionally identical components shown in the drawings.

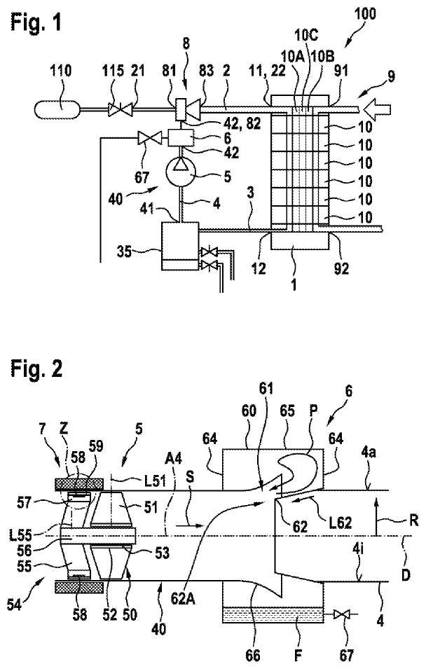

FIG. 1 shows an example of a fuel cell system 100. As shown by way of example in FIG. 1, fuel cell system 100 can comprise a fuel cell assembly 1, a supply line 2, a discharge line 3, a recirculation line 4, a recirculation compressor 5, a water separator 6, and an optional suction jet pump 8. Furthermore, an oxygen supply section 9 can be provided.

The fuel cell assembly 1 can have a plurality of fuel cells 10 arranged in a stack, as exemplified in FIG. 1. However, it is also generally conceivable that only one fuel cell 10 is provided. As shown schematically in FIG. 1, each fuel cell 10 can comprise an anode 10A, a cathode 10B, and an electrolyte 10C arranged between them, e.g., in the form of an electrolyte membrane.

The fuel cell assembly 1 can further comprise a fuel inlet 11 via which gaseous fuel, e.g., hydrogen or natural gas, can be supplied to anode 10A and a fuel outlet 12 via which unused or unreacted fuel can be discharged from anode 10A. Unconsumed fuel discharged at the fuel outlet 12 can also be referred to as excess fuel.

For example, the oxygen supply section 9 can comprise an oxygen inlet 91 via which gaseous oxygen, either as pure oxygen or as oxygen contained in ambient air, can be supplied to the cathode 10B and a product outlet 92 via which unused or unreacted oxygen as well as chemical reaction products, in particular water, can be discharged from the cathode 10B.

The supply line 2 serves to supply the fuel into the fuel inlet 12. Accordingly, the supply line 2 is connected to the fuel inlet 12, e.g., an outlet 22 of the supply line can be connected to the fuel inlet 12. For example, an inlet 21 of supply line 2 can be connected to a fuel tank 110, e.g., via a valve 115, wherein fuel is stored under pressure in fuel tank 110, as exemplified in FIG. 1. However, it is also conceivable that the inlet 21 can be connected to another fuel source.

As further shown in FIG. 1, the discharge line 3 can be connected to fuel outlet 12 of fuel cell assembly 1. For example, an inlet 31 of the discharge line 3 can be connected to the fuel outlet 12. The discharge line 3 serves to remove the excess fuel from the anode 10A. As product water can pass through the electrolyte 10C from the cathode 10B to the anode 10A, the fuel outlet 12 can have a mixture of gaseous fuel and liquid and/or gaseous water.

Recirculation line 4 connects discharge line 3 and supply line 2 to re-supply the excess fuel accumulating at fuel outlet 12 to fuel inlet 11 via supply line 2 or recirculate the excess fuel. The recirculation line 4 can generally be realized as a tube or in a channel. The recirculation line 4 generally has an inner circumferential surface 4i defining the flow cross-section and an oppositely oriented outer circumferential surface 4a (FIG. 2). The inner circumferential surface 4i further defines a central axis A4 of the recirculation line. For example, the recirculation line 4 can comprise a linear line section 40 in which the central axis A4 is a straight line and in which the recirculation line 4 is straight or linear, as exemplified in FIG. 2.

As further shown in FIG. 1, an outlet 32 of the discharge line 3 can be connected to an optional water pre-separator 35, for example, to which an inlet 41 of the recirculation line 4 is also connected. Of course, the inlet 41 of the recirculation line 4 and the outlet 32 of the discharge line 3 can also be directly connected to each other. Likewise, further hydraulic components, e.g., valves or the like, can be switched between the outlet 32 of the discharge line 3 and the inlet 41 of the recirculation line 4. For example, the first water pre-separator 35 can comprise an internal channel or lamella system through which the excess fuel is directed, wherein water contained in the flow is partially deposited due to centrifugal forces and/or under the influence of gravity.

The recirculation compressor 4 is merely symbolically shown in FIG. 1. FIG. 2 shows a recirculation compressor 5, purely by way of example, which comprises a stator 50 with stator blades 51 and rotor 54 with rotor blades 55. As shown by way of example in FIG. 2, the recirculation compressor 5 can be arranged in the linear line section 40 of the recirculation line 4 independent of its specific design.

For example, the stator 50, in particular the stator blades 51, can be attached to the inner circumferential surface 4i of the recirculation line 4, as exemplified in FIG. 2. The stator 50 can comprise a hub 52 from which the stator blades 51 extend along a radial direction R that is perpendicular to the central axis A4. The stator blades 51 can further be rotated about a blade longitudinal axis L51 extending in the radial direction R relative to the central axis A4, so that a line of connection between a leading edge and a trailing edge of the respective blade 51 is angled, e.g., at an acute angle to the central axis A4. A flow flowing along the central axis A4 is thus subjected to a swirl or is deflected by the blades such that the flow has a speed component directed along the central axis A4 and a speed component in the radial direction. Furthermore, the hub 52 can comprise a bearing 53 defining an axis of rotation D. For example, the axis of rotation D can coincide with or coaxially extend to the central axis A4, as exemplified in FIG. 2.

Rotor 54 can have a rotor shaft 56 from which rotor blades 55 extend along the radial direction R. Rotor shaft 56 can be supported in the bearing 53 of stator 50, as shown by way of example in FIG. 2, and thus can be rotated about the axis of rotation D. Generally, rotor 54 can be rotatably supported on stator 50 about an axis of rotation D. The axis of rotation D can extend in particular perpendicular to the radial direction R. It is shown as an example in FIG. 2 that rotor 54 is arranged between the input 41 of recirculation line 4 and stator 50. However, it is also conceivable that the stator 50 is arranged between the input 41 of the recirculation line 4 and the rotor 54.

For example, the stator blades 55 can further be rotated about a blade longitudinal axis L55 extending in the radial direction R relative to the central axis A4, so that a line of connection between a leading edge and a trailing edge of the respective blade 55 is angled, e.g., at an acute angle to the central axis A4. Preferably, the rotor blades 55 are inclined about their blade longitudinal axis L55 opposite to the stator blades 51. Generally, the stator blades 51 and the rotor blades 55 can be inclined relative to one another such that flow is generated by rotation of the rotor 54 about the axis of rotation D, which has a speed component along the axis of rotation D and a speed component in a circumferential direction perpendicular to the radial direction R. Thus, the compressor is configured to generate a fluid flow of the excess fuel from the discharge line 3 to the supply line 2, which comprises a speed component in a circumferential direction, i.e., around the central axis A4 or around the axis of rotation D.

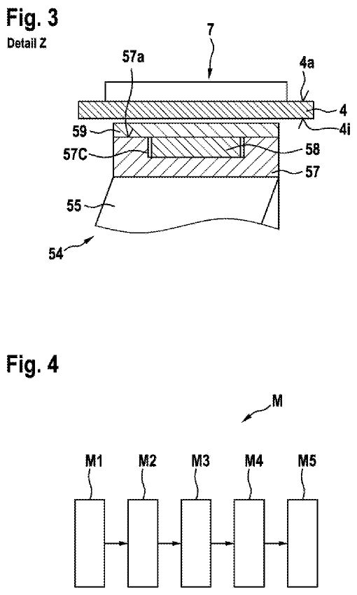

As further shown in FIG. 2, compressor 5 can include an optional carrier ring 57. As shown in FIG. 3 with more details, the carrier ring 57 can have an inner circumferential surface 57i and an oppositely oriented outer circumferential surface 57a. For example, the carrier ring 57 can be arranged in the recirculation line 4 to enclose the central axis A4 or the axis of rotation D. As shown schematically in FIGS. 2 and 3, the rotor blades 55 can be held inwardly with respect to the radial direction R on a carrier ring 57, e.g., by being secured to the inner circumferential surface 4i. For example, the carrier ring 57 and the blades 55 can be made in one piece or welded.

As shown in FIG. 2 and with more details in FIG. 3, the carrier ring 57 can have recesses 57C on the outer circumferential surface 57a in which permanent magnets 58 are arranged. For example, a plurality of recesses 57C can be provided along the circumference of the carrier ring 57, wherein a permanent magnet 58 is received in each recess 57C. It is also generally conceivable that permanent magnets 58 can be arranged outside of recesses 57C on the outer circumferential surface 57a of the carrier ring 57. Similarly, it is generally conceivable that permanent magnets 58 are arranged on the inner circumferential surface 57i of the carrier ring, either protruding or in corresponding recesses. Generally, the permanent magnets 58 are attached to the carrier ring 57.

Further optionally, a sleeve 59 can be provided, which is arranged on the outer circumferential surface 57a of the carrier ring 57 and covers the recesses 57C and the permanent magnets 58 arranged therein. The sleeve 59 can be connected to the outer circumferential surface 57a of the carrier ring 57, e.g., bolted, glued, welded or in a similar manner.

As shown schematically in FIG. 2, an electrical coil array 7 can be arranged outwardly on the recirculation line 4 with respect to the radial direction R. The coil array 7 can in particular be arranged on the outer circumferential surface 4a. The coil array 7 is positioned along the central axis A4 or the axis of rotation D at the location of the rotor 54, in particular at the location of the permanent magnets 57. As shown schematically in FIG. 2, the coil array 7 can extend around the entire outer circumference of the recirculation line 4. For example, the coil array 7 can comprise a plurality of induction coils that are arranged and distributed around the circumference of the recirculation line 4 or a continuous winding circumscribing the recirculation line 4. The coil array 7 is generally configured to generate a magnetic field rotating about the axis of rotation D. The rotating magnetic field exerts a circumferential force on the permanent magnets 58, thereby rotating the rotor 54 about the axis of rotation D.

The speed component along the axis of rotation D generated by rotation of the rotor 54 can therefore be referred to as the main flow direction S, which is symbolically represented in FIG. 2 by arrow S. Due to the speed component running in the circumferential direction or the swirl of the flow, liquid constituents of the flow or components of high mass are transported outwardly in the radial direction R as a result of inertial forces.

As shown schematically in FIG. 1, the water separator 6 is arranged between the recirculation compressor 5 and the supply line 2 on the recirculation line 4. In particular, as shown by way of example in FIG. 1, the water separator 6 can be arranged between the compressor 5 and an outlet 42 of the recirculation line 4.

In FIG. 2, the water separator 6 is shown exemplary and schematically in section. As shown in FIG. 2, the, water separator 6 can include a receiving chamber 60 and an optional guide piece 62. The receiving chamber 60 is arranged on the recirculation line 4 with respect to the radial direction R outwards, e.g., in the linear line section 40. For example, the receiving chamber 60 can be arranged on the outer circumferential surface 4a of the recirculation line 4. Optionally, the receiving chamber 60 can completely enclose the outer circumference 4a of the recirculation line 4. For example, as shown by way of example in FIG. 2, the receiving chamber 60 can be configured as a housing or channel extending along the circumferential direction around the recirculation line 4, which comprises side walls 64 extending in the radial direction R and a ceiling wall 65 connecting the side walls 64 extending in the circumferential direction. Generally, the receiving chamber 60 defines a receiving space, e.g., between the walls 64, 64 and the outer circumferential surface 4a of the recirculation line 4.

As shown by way of example in FIG. 2, the recirculation line 4 comprises a discharge opening 61, which is formed downstream of the recirculation compressor 5 or between the recirculation compressor 5 and the supply line 2. The discharge opening 61 can be spaced at a predetermined minimum distance from recirculation compressor 4 so that sufficient time is available for transport of the liquid constituents outward in the radial direction R after the flow has been subjected to a swirl. As shown schematically and by way of example in FIG. 2, the discharge opening 61 fluidly connects the recirculation line 4 to the receiving space of the receiving chamber 60.

For example, the discharge opening 61 can be defined by the optional guide piece 62 and an optional wall piece 66, as exemplified in FIG. 2. The wall piece 66 is formed by a circumferential section of a wall of the recirculation line 4, which is bent outwards with respect to the radial direction R and runs at an angle relative to the central axis A4. For example, the wall piece 66 can extend along the entire circumference of the recirculation line 4 such that a funnel-shaped widening is formed, as shown by way of example in FIG. 2. For example, a free end of the wall piece 66 can project into the receiving space of the receiving chamber 60.

The guide piece 62 is formed by a circumferential section of the wall of the recirculation line 4, which is bent inwards with respect to the radial direction R. For example, the guide piece 62 can extend in an extension direction L62 at an angle relative to an inner circumferential surface 4i of the recirculation line 4 such that a free end 62A of the guide piece 62 faces the recirculation compressor 5. The extension direction L62 is thus angled relative to the central axis A4. As shown by way of example in FIG. 2, the wall piece 66 can extend along the entire circumference of the recirculation line 4 such that a funnel-shaped widening is formed. As shown by way of example in FIG. 2, wall piece 66 and guide piece 62 can overlap along central axis A4. In general, the wall piece 66 and the guide piece 62 can define an annular channel to the central axis A4 or axis of rotation D, which forms the draining opening 61 and connects the recirculation line 4 to the receiving chamber 60.

It is also generally conceivable that the wall piece 66 is not angled, but runs parallel to the central axis A4. Further, the guide piece 62 can also extend parallel to the radial direction R. In general, the optional guide piece 62 projects into the recirculation line 4 with respect to the radial direction R and partially circumscribes the discharge opening 61. Furthermore, it is also conceivable that the guide piece 62 is omitted and a simple recess extending between the inner circumferential surface 4i and the outer circumferential surface 4a forms the discharge opening 61.

In a water separator 6, in which a guide piece 62 extending at an angle to the central axis A4 is provided, as shown by way of example in FIG. 2, it can optionally also be provided that the receiving chamber 60 comprises a wall 64 extending along the radial direction R, which is arranged at a distance from the guide piece 62 in the extension direction L62. For example, the side wall 64 extending in the radial direction R, which is positioned facing away from the compressor 5, can be arranged at an area of the guide piece 62 facing away from the free end 62A. As shown symbolically in FIG. 2 by arrow P, this arrangement can facilitate a recirculation of the flow between the receiving chamber 60 and the recirculation line 4.

When the excess fuel flows in the recirculation line 4 from the discharge line 3 to the supply line 2, it is subjected to a swirl by the recirculation compressor 5, whereby the flow receives a speed component in the circumferential direction. If the compressor 5 has inclined stator and/or rotor blades 51, 55, the flow is also twisted if the compressor 5 is not operated, that is to say, even if the rotor 54 is not driven. Due to the swirl, liquid constituents of the flow, such as water that accumulates at the anode 10A and is carried in the flow with the excess fuel, are transported outwards in the radial direction R. Liquid constituents can be discharged into the receiving chamber 60 through the opening 61, where they are collected as liquid F. As shown by way of example and schematically in FIG. 2, liquid F can be discharged from receiving chamber 60 at intervals via, for example, a valve 67.

The optional suction jet pump 8 can be arranged in the supply line 2, as shown schematically in FIG. 1. The suction jet pump 8 may, for example, comprise a propel nozzle 81 connected to the inlet 21 of the supply line 2, a suction inlet 82 connected to the outlet 42 of the recirculation line 4, and an outlet 83 connected to the fuel inlet 11 of the fuel cell assembly 1 or to the outlet 22 of the supply line 2. When fuel is supplied to the suction jet pump 8 at its propel nozzle 81, e.g. from the reservoir 110, excess fuel is drawn from the discharge line 3 through the suction inlet 82 through the recirculation line 4 and output at the outlet 83. Thus, the optional suction jet pump 8 is configured to generate a fluid flow of the excess fuel from the discharge line 3 to the supply line 2. The recirculation compressor 5 can optionally be operated simultaneously with the suction jet pump 8. For example, only the suction jet pump 8 can be operated.

FIG. 4 schematically illustrates the flow of a method M for operating a fuel cell system. In the following, the method M is explained with reference to the fuel cell system 100 described above, but is not limited to this.

In a first step M1, a gaseous fuel is supplied to a fuel inlet 11 of a fuel cell assembly 1. For example, fuel, e.g., hydrogen, can be supplied through the supply line 2 to the fuel inlet 11 by means of the suction jet pump 8 to supply the anode 10A. At the same time, oxygen can be supplied to the cathode 10B via the oxygen supply section 9.

In step M2, surplus unreacted fuel is discharged as excess fuel from the fuel cell assembly 1, e.g., through the discharge line 3 connected to the fuel outlet 12.

Furthermore, a swirling flow of the excess fuel is generated M3, which comprises a speed component in a circumferential direction. This can be done, for example, using recirculation compressor 5, as described above. For example, recirculation compressor 5 can operate to rotate the rotor 54 of recirculation compressor 5. However, it is also conceivable that the recirculation compressor 5 is not operated actively, but rather the flow is exclusively generated by the suction jet pump 8, which draws in the excess fuel at its suction inlet 82. The flow can still be provided with a swirl through the blades 51, 55 of the compressor 5. Alternatively, it is also conceivable that the recirculation compressor 5 is omitted and a guide structure is provided in the recirculation line 4 instead of the compressor 5, which is configured to generate a circumferentially directed speed component in the flow of the excess fuel. For example, the guide structure can be formed by a stator 50 as described for the recirculation compressor 5.

In a further step M4, the swirling flow is directed via a flow surface 4i, which is directed perpendicular to the radial direction R or extends circumferentially, in which at least one discharge opening 61 is formed. Liquid constituents of the flow are drained into a collection container 60 through the discharge opening 61. For example, the discharge opening 61 and the collection container 60 can be configured as described above. Furthermore, a recirculation M5 of the fuel cell excess to the fuel inlet 11, e.g., through the recirculation line 4 and the supply line 2, as described above.

Although the present invention has been explained above with reference to embodiment examples, the invention is not limited thereto and can instead be modified in a variety of ways. Combinations of the preceding embodiment examples are in particular also conceivable.

1. A fuel cell system (100) comprising:
a fuel cell assembly (1) with at least one fuel cell (10), a fuel inlet (11) and a fuel outlet (12);
a supply line (2) connected to the fuel inlet (11) for supplying gaseous fuel;
a discharge line (3) connected to the fuel outlet (12) for discharging excess fuel;
a recirculation line (4) connected to the discharge line (3) and the supply line (2):
a recirculation compressor (5) arranged in the recirculation line (4), which is configured to generate a fluid flow of excess fuel from the discharge line (3) to the supply line (2), said fluid flow having a speed component in a circumferential direction of the recirculation line (4); and
a water separator (6) which is arranged between the recirculation compressor (5) and the supply line (2) and which comprises a receiving chamber (60) arranged on an exterior of the recirculation line (4) with respect to a radial direction (R) and which is connected to the recirculation line (4) via at least one discharge opening (61) formed in the recirculation line (4) in order to receive liquid constituents contained in the fluid flow.

2. The fuel cell system (100) according to claim 1, wherein
the receiving chamber (60) of the water separator (6) encloses an outer circumference (4a) of the recirculation line (4).

3. The fuel cell system (100) according to claim 1,
wherein the water separator (6) comprises a guide piece (62) projecting into the recirculation line (4) with respect to the radial direction (R), which partially circumscribes the discharge opening (61).

4. The fuel cell system (100) according to claim 3, wherein the guide piece (62) extends in an extension direction (L62) at an angle relative an inner circumferential surface (4i) of the recirculation line (4), such that a free end (62A) of the guide piece (62) faces the recirculation compressor (5), and wherein the receiving chamber (60) comprises a wall (64) extending along the radial direction (R), which is arranged at a distance from the guide piece (62) in the extension direction (L62).

5. The fuel cell system (100) according to claim 1, wherein the recirculation compressor (5) comprises a stator (50) with stator blades (51) and a rotor (54) with rotor blades (55) rotatably mounted on the stator (50) about an axis of rotation (D), wherein the axis of rotation (D) extends perpendicular to the radial direction (R), and wherein the stator blades (52) and the rotor blades (55) are inclined relative to one another, wherein flow is generated by a rotation of the rotor (54) about the rotation axis (D), which comprises a speed component along the axis of rotation (D) and a speed component along the circumferential direction.

6. The fuel cell system (100) according to claim 5, wherein the rotor blades (55) are held inwardly on a carrier ring (57) with respect to the radial direction (R).

7. The fuel cell system (100) according to claim 6, wherein permanent magnets (58) are attached to the carrier ring (57), and wherein an electrical coil arrangement (7) is arranged on an outer circumference (4a) of the recirculation line (4), which is configured to generate a magnetic field rotating about the axis of rotation (D) to rotate the rotor (54) about the axis of rotation (D).

8. The fuel cell system (100) according to claim 7, wherein the carrier ring (57) on an outer circumferential surface (57a) comprises recesses (57C) in which the permanent magnets (58) are arranged, and wherein one of the recesses (57C) and a sleeve (59) covering the permanent magnets arranged therein is arranged on the outer circumferential surface (57a) of the carrier ring (57).

9. The fuel cell system (100) according to claim 1, further comprising:
a suction jet pump (8) arranged in the supply line (4) having a propel nozzle (81) connected to an inlet (21) of the supply line, a suction inlet (82) connected to the recirculation line (4), and an output (83) connected to the fuel inlet (11) of the fuel cell assembly (1).

10. A method (M) for operating a fuel cell system, the method comprising:
supplying (M1) a gaseous fuel to a fuel inlet (11) of a fuel cell assembly (1);
discharging (M2) excess fuel from the fuel cell assembly (1);
generating (M3) a swirling flow of the excess fuel comprising a speed component in a circumferential direction;
directing (M4) the swirling flow across a flow surface (4i) extending along the circumferential direction, in which at least one discharge opening (61) is formed, through which liquid constituents of the flow are drained into a collection container (60); and
recirculating (M5) the fuel cell excess to the fuel inlet.
